(19) United States
(12) Patent Application Publication
(10) Pub. No.: US 2007/0231609 A1
(43) Pub. Date: Oct. 4, 2007

(54) Perpendicular magnetic recording medium and magnetic memory apparatus

(75) Inventors: Antony Ajan, Kawasaki (JP); Toshio Sugimoto, Kawasaki (JP); Ryo Kurita, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki (JP)

(21) Appl. No.: 11/505,943

(22) Filed: Aug. 18, 2006

(30) Foreign Application Priority Data
Mar. 31, 2006 (JP) 2006-100596

(51) Int. Cl. G11B 5/66

(52) U.S. Cl. 428/828.1; 428/829; 428/830

(57) ABSTRACT

A perpendicular magnetic recording medium is disclosed that includes a substrate, and a recording layer formed on the substrate, the recording layer having a magnetic easy axis substantially perpendicular to the surface of the substrate and including three or more magnetic layers containing a Co alloy having a hcp structure. The two of the magnetic layers included in the recording layer form an anti-ferromagnetic exchange coupling structure. The two magnetic layers are anti-ferromagnetically exchange coupled via a non-magnetic coupling layer situated therebetween. The magnetizations of the two magnetic layers are anti-parallel to each other at a remanent magnetization state.

### BACKGROUND OF THE INVENTION

1. Field of the Invention

The present invention generally relates to a perpendicular magnetic recording medium and a magnetic memory apparatus.

2. Description of the Related Art

In recent years and continuing, magnetic memory apparatuses are used in diverse areas such as large scale systems, personal computers, and communication devices. The magnetic memory apparatuses are desired to have higher recording density and faster transfer rates.

With a perpendicular magnetic recording method, the length of a single bit does not change even when recording density is increased owing that information is recorded by magnetizing a recording layer of a magnetic recording medium in a perpendicular direction with to the substrate surface. Therefore, demagnetization does not increase. Hence, the bits recorded by using the perpendicular magnetic recording method are more stable than those recorded by using a longitudinal recording method and have greater thermal stability (thermal stability of residual magnetization). Therefore, the perpendicular magnetic recording method is expected to record and reproduce in a density higher than that of the longitudinal recording method.

A continuous layer using a ferromagnetic material or a so-called granular layer having ferromagnetic grains surrounded by a non-magnetic material is used as a recording layer a perpendicular magnetic recording medium. In conducting high density recording with the perpendicular magnetic recording method, a ferromagnetic material having high anisotropic magnetic field is used for ensuring satisfactory read/write property and thermal stability of residual magnetization. Since the use of the ferromagnetic material having high anisotropic magnetic field increases the magnetic field strength for reversing the magnetization of the recording layer (i.e. magnetic field reversing strength), a sufficient recording magnetic field strength is required for reversing magnetization.

However, in order to increase the recording magnetic field strength, a soft magnetic material having a higher saturation flux density is to be used as the material of the magnetic pole of a recording element of a magnetic head. It is, however, difficult to find such soft magnetic material. This results in a problem of being unable to obtain a recording element having such sufficient recording magnetic field strength and sufficiently reverse the magnetization of the recording layer. Accordingly, it is desired to prevent the magnetic field reversing strength of the recording layer from increasing. That is, it is desired to ensure satisfactory writing ability (writability) of the perpendicular magnetic recording medium.

### SUMMARY OF THE INVENTION

The present invention may provide a perpendicular magnetic recording medium and a magnetic memory apparatus that substantially obviates one or more of the problems caused by the limitations and disadvantages of the related art.

Features and advantages of the present invention will be set forth in the description which follows, and in part will become apparent from the description and the accompanying drawings, or may be learned by practice of the invention according to the teachings provided in the description. Objects as well as other features and advantages of the present invention will be realized and attained by a perpendicular magnetic recording medium and a magnetic memory apparatus particularly pointed out in the specification in such full, clear, concise, and exact terms as to enable a person having ordinary skill in the art to practice the invention.

To achieve these and other advantages and in accordance with the purpose of the invention, as embodied and broadly described herein, an embodiment of the present invention provides a perpendicular magnetic recording medium including: a substrate; and a recording layer formed on the substrate, the recording layer having a magnetic easy axis substantially perpendicular to the surface of the substrate and including three or more magnetic layers containing a Co alloy having a hcp structure; wherein two of the magnetic layers included in the recording layer form an anti-ferromagnetic exchange coupling structure; wherein the two magnetic layers are anti-ferromagnetically exchange coupled via a non-magnetic coupling layer situated therebetween; wherein the magnetizations of the two magnetic layers are anti-parallel to each other at a remanent magnetization state.

Furthermore, another embodiment of the present invention provides a magnetic memory apparatus including: a recording/reproduction part having a magnetic head; and the perpendicular magnetic recording medium according to one of the embodiments of the present invention.

Other objects and further features of the present invention will be apparent from the following detailed description when read in conjunction with the accompanying drawings.

### BRIEF DESCRIPTION OF THE DRAWINGS

FIG. 1 is a cross-sectional view showing a first example of a perpendicular magnetic recording medium according to a first embodiment of the present invention;

FIG. 2 is a cross-sectional view showing a second example of a perpendicular magnetic recording medium according to the first embodiment of the present invention;

FIG. 3 is a cross-sectional view showing a third example of a perpendicular magnetic recording medium according to the first embodiment of the present invention;

FIG. 4 is a cross-sectional view showing a fourth example of a perpendicular magnetic recording medium according to the first embodiment of the present invention;

FIG. 5A is a table showing a hysteresis curve of the first sample of the perpendicular magnetic recording medium according to the first embodiment of the present invention;

FIG. 5B is a table showing magnetic properties of the first sample of the perpendicular magnetic recording medium according to the first embodiment of the present invention;

FIG. 6 is a table showing reading/writing properties of the first sample of the perpendicular magnetic recording medium according to the first embodiment of the present invention;

FIG. 7 is a table showing a hysteresis curve of the second sample of the perpendicular magnetic recording medium according to the first embodiment of the present invention;

FIG. 8 is a table showing reading/writing properties of the second sample of the perpendicular magnetic recording medium according to the first embodiment of the present invention; and

FIG. 9 is a schematic plan view of a part of a magnetic memory apparatus according to a second embodiment of the present invention.

### DESCRIPTION OF THE PREFERRED EMBODIMENTS

In the following, embodiments of the present invention are described with reference to the accompanying drawings.

### First Embodiment

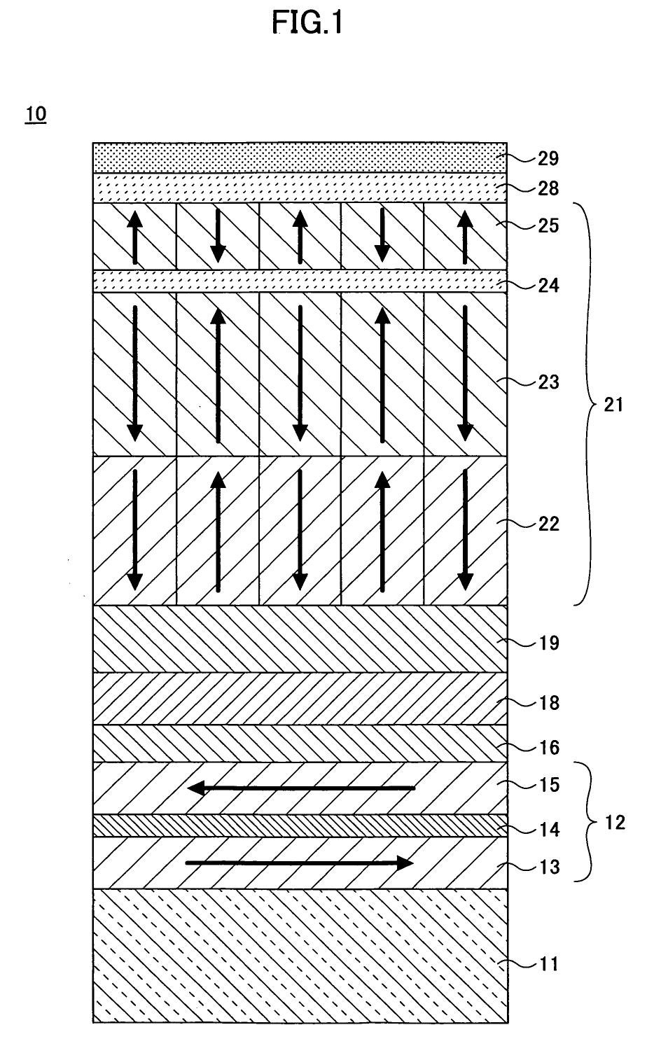

FIG. 1 is a cross-sectional view showing a perpendicular magnetic recording medium 10 (first example) according to the first embodiment of the present invention.

In FIG. 1, the perpendicular magnetic recording medium 10 includes a substrate 11 and a multilayer configuration provided on the substrate 11, in which the multilayer configuration includes a soft magnetic under layered structure 12, a separating layer 16, an under-layer 18, an intermediate layer 19, a recording layer 21, a protective layer 28, and a lubricant layer 29 that are layered on the substrate 11 in this order. The recording layer 21 includes a first magnetic layer 22, a second magnetic layer 23, a non-magnetic coupling layer 24, and a third magnetic layer 25 that are layered on the intermediate layer 19 in this order. The recording layer 21 includes an anti-ferromagnetic exchange coupling structure having the second magnetic layer 23 anti-ferromagnetically exchange-coupled to the third magnetic layers 23 via the non-magnetic coupling layer 24.

The substrate 11 includes, for example, a plastic substrate, a glass substrate, a Si substrate, or an aluminum alloy substrate. In a case where the perpendicular magnetic recording medium 10 is a magnetic disk, a disk-shaped substrate may be used. In a case where the perpendicular magnetic recording medium 10 is a magnetic tape, a polyester film (PET), a polyethylene naphthalate film (PEN), or a highly heat resistant polyimide film, for example, may be used as the substrate 11.

The soft magnetic under layered structure 12 includes, for example, two amorphous soft magnetic material layers 13, 15 and a non-magnetic coupling layer 14 provided therebetween. The magnetization of the amorphous soft magnetic material layer 13 and the magnetization of the amorphous soft magnetic material layer 15 are anti-ferromagnetically coupled via the non-magnetic coupling layer 14. Each of the amorphous soft magnetic material layers 13, 15 has a thickness ranging, for example, from 50 nm to 2 μm, and includes an amorphous soft magnetic material having at least one of, for example, Fe, Co, Ni, Al, Si, Ta, Ti, Zr, Hf, V, Nb, C, and B. More specifically, the material included the amorphous soft magnetic material layers 13, 15 may be, for example, FeSi, FeAlSi, FeTaC, CoNbZr, CoCrNb, CoFeB, and NiFeNb.

In the case where the substrate 11 is a disk-shaped substrate, the magnetic easy axis of the amorphous soft magnetic material layers 13, 15 is preferred to be oriented in radial direction of the substrate 11. Accordingly, in a remanence state, the magnetization of the amorphous soft magnetic material layer 13 is, for example, oriented to the inner peripheral direction of the substrate 11 and the magnetization of the amorphous soft magnetic material layer 15 is, for example, may be oriented to the outer peripheral direction of the substrate 11. Thereby, magnetic domains can be prevented from being formed in the amorphous soft magnetic material layers 13, 15, and magnetic field leakage can be prevented from occurring at the interface between magnetic domains.

The amorphous soft magnetic material layer 13 and the amorphous soft magnetic material layer 15 are preferred to use soft magnetic materials of substantially the same composition. Furthermore, the amorphous soft magnetic material layer 13 and the amorphous soft magnetic material layer 15 are preferred to have substantially the same thickness. Thereby, a magnetic field leaking from one amorphous soft magnetic material layer 13 (15) can be cancelled by a magnetic field leaking from the other amorphous soft magnetic material layer 15 (13). Accordingly, the noise from a reproduction element of a magnetic head can be reduced. It is, however, to be noted that the amorphous soft magnetic material layer 13 and the amorphous soft magnetic material layer 15 may use soft magnetic materials of different composition.

The non-magnetic coupling layer 14 includes a non-magnetic material having at least one of, for example, Ru, Cu, Cr, Rh, Ir, an Ru alloy, an Rh alloy, and an Ir alloy. The Ru alloy may preferably be an alloy including Ru and at least one of Co, Cr, Fe, Ni, and Mn. The thickness of the non-magnetic coupling layer 14 is set in a range that allows the amorphous soft magnetic material layer 13 and the amorphous soft magnetic material layer 15 to become anti-ferromagnetically exchange coupled. The range may be, for example, from 0.4 nm to 1.5 nm.

The soft magnetic under layered structure 12 may also be configured as a layered structure having a non-magnetic coupling layer and another amorphous soft magnetic material layer further layered on top of the amorphous soft magnetic material layer 15 or as a plurality of such layered structures. It is preferred that the summation of the product between the thickness and the residual magnetization of the unit volume of each amorphous soft magnetic material layer 15 in the soft magnetic under layered structure 12 becomes approximately 0. Thereby, the leakage flux of the soft magnetic under layered structure 12 can be approximately 0.

Although the soft magnetic under layered structure 12 is preferred to be configured as described above, the soft magnetic under layered structure 12 may use crystalline soft magnetic material layers (e.g. NiFe or an NiFe alloy) instead of the amorphous soft magnetic material layers 13, 15. Alternatively, the soft magnetic under layered structure 12 may omit the amorphous soft magnetic material layer 15 and be configured with a single amorphous soft magnetic material layer 13. Alternatively, the soft magnetic under layered structure 12 itself may be omitted depending on the structure of the recording element of the recording head.

The separating layer 16 has a thickness of, for example, 2.0 nm to 10 nm. The separating layer 16 includes an amorphous non-magnetic material having at least one of, for example, Ta, Ti, Mo, W, Re, Os, Hf, Mg, and Pt. Since the separating layer 16 is in an amorphous state, the separating layer 16 does not affect the crystal orientation of the under-layer 18. This makes it easier for the under-layer 18 to self-organize its crystals and attain a desired crystal orientation. Thereby, the crystal orientation of the under-layer 18 is improved. Furthermore, the separating layer 16 enables the crystal grains of the under-layer 18 to be evenly distributed. Moreover, since the separating layer 16 is of a non-magnetic material, the separating layer 16 separates the magnetically coupling between the amorphous soft magnetic material layer 15 and the under-layer 18.

There is no particular limit regarding the material of the under-layer 18 as long as it is a crystalline material that improves the crystal orientation of the intermediate layer 19 provided thereon. The material of the under-layer 18 includes, for example, Al, Cu, Ni, Pt, NiFe, and NiFe—X2. Here, X2 includes at least one of, for example, Cr, Ru, Cu, Si, O, N, and SiO₂. It is preferable for the under-layer 18 to include at least one of Ni, NiFe, and NiFe—X2. Since the (111) crystal plane of the under-layer 18 serves as the growth plane, crystal growth of the intermediate layer 19 can occur with a satisfactory lattice arrangement in a case where the intermediate layer 19 includes Ru or Ru—X1 (described below). Thereby, crystallinity and crystal orientation of the recording layer 21 situated on the intermediate layer 19 can be improved and perpendicular coercivity can be enhanced. As a result, satisfactory thermal stability of residual magnetization can be attained.

The material of the intermediate layer 19 is not to be limited as long as the material of the intermediate layer 19 enables the crystal growth of the intermediate layer 19 to occur on the intermediate layer 18, and as long as the material of the intermediate layer 19 enables crystal growth of the recording layer 21 to occur on the surface of the intermediate layer 19. The material of the intermediate layer 19 includes at least one type of non-magnetic material, for example, Ru, Pd, Pt, and Ru alloy. The Ru alloy includes, for example, an Ru—X1 alloy (wherein X1 includes at least one of, for example, Ta, Nb, Co, Cr, Fe, Ni, Mn, SiO₂, and C) having a hcp (hexagonal close-packed) structure.

Since the respective magnetic layers comprising the recording layer 21 include Co alloy having a hcp structure (described below), it is preferable to use Ru or Ru—X1 alloy as the material of the intermediate layer 19 for attaining a satisfactory lattice arrangement. Accordingly, the (0002) crystal plane of Co grows on the (0002) crystal plane of Ru. Thereby, the c axis (magnetic easy axis) can be satisfactorily oriented perpendicular to the substrate surface.

Alternatively, the intermediate layer 19 may have a structure in which Ru crystal grains or Ru alloy crystal grains (hereinafter referred to as “Ru crystal grains”) are spatially separated from each other (hereinafter referred to as “intermediate layer structure A”). Since the Ru crystal grains are substantially evenly separated from each other in the intermediate layer 19, the magnetic grains in the recording layer 21 can also be arranged in a similar manner as the Ru crystal grains. Thereby, the distribution width of the magnetic grains can be reduced. As a result, medium noise is reduced and SN ratio can be improved. In this example, the intermediate layer 19 is formed by performing a sputtering method with Ru or RU-X1 alloy. The sputtering is performed in an inert atmosphere (e.g. Ar gas) where the deposition rate is 2 nm/sec. or less and the ambient pressure is 2.66 Pa or more. It is preferable to set the deposition rate to 0.1 nm/sec. or more for preventing productivity from decreasing. Oxygen gas may be added to the inert gas for enhancing separating property among the Ru crystal grains.

Alternatively, the intermediate layer 19 may have a structure in which a non-solid solution layer surrounds Ru crystal grains and the Ru crystal grains are separated from each other (hereinafter referred to as “intermediate layer structure B”). Also with this structure, the magnetic grains in the recording layer 21 can be arranged in a similar manner as the Ru crystal grains since the Ru crystal grains are substantially evenly separated from each other in the intermediate layer 19. Thereby, the distribution width regarding the grain size of the magnetic grains can be narrowed. As a result, medium noise is reduced and SN ratio can be improved. The material is not to be limited as long as it is a non-solid solution with respect to Ru or Ru—X1 alloy. It is preferred to be a compound, in which one element of the compound is one of Si, Al, Ta, Zr, Y or Ti and the other element of the compound is one of O, N or C. The material of the non-magnetic material may include, for example, an oxide material such as SiO₂, Al₂O₃, Ta₂O₅, ZrO₂, Y₂O₃, TiO₂, MgO, a nitride material such as Si₃N₄, AlN, TaN, ZrN, TiN, Mg₃N₂, or a carbide material such as SiC, TaC, ZrC, TiC.

The recording layer 21 includes the first magnetic layer 22, the second magnetic layer 23, the non-magnetic coupling layer 24, and the third magnetic layer 23 that are layered in this order. The first-third magnetic layers, 22, 23, and 25 include a ferromagnetic material comprising a Co alloy having an hcp structure. In the first-third magnetic layers 22, 23, and 25, the Co (0002) crystal plane becomes the primary orientation of growth, and the c axis (i.e. magnetic easy axis) is arranged substantially perpendicular to the surface of the substrate 11. The crystals of the first-third magnetic layers 22, 23, and 25 are oriented in accordance with the crystal orientation of the intermediate layer 19.

The material included in the first-third magnetic layers 22, 23, and 25 may be, for example, CoCr, CoPt, CoCrTa, CoCrPt, and CoCrPt-M (M includes at least one of, for example, B, Ta, Cu, W, Mo, and Nb). The first-third magnetic layers 22, 23, and 25 may be plural ferromagnetic films being in intimate contact via a granular part containing magnetic grains of ferromagnetic material comprising Co alloy having an hcp structure. It is preferable for the third magnetic layer 25 to comprise CoCr. Since the CoCr has a grain segregated structure and includes no element but Co and Cr, a satisfactory crystallinity can be attained. Furthermore, since the CoCr includes no element but Co and Cr, a high saturation magnetic flux density can be set. The composition of CoCr is preferred to be 15 at % or less owing that saturation magnetization becomes higher as the amount of Cr contained (i.e. Cr content) becomes lower. In a case where the Cr content is greater than 15 at % and no greater than 30 at %, it is preferred for the layer to be thicker than the case where the Cr content is 15 at % or less. This owes to the fact that, although the saturation magnetization is decreased, the segregation structure is promoted.

Alternatively, it is also possible for the recording layer 21 to have a structure in which at least one of the first magnetic layer 22 and the second magnetic layer 23 includes ferromagnetic grains comprising Co alloy having an hcp structure and a non-solid solution layer surrounding grain segregated magnetic grains (hereinafter referred to as “ferromagnetic granular structure layer”). By forming the recording layer 21 with the ferromagnetic granular structure layer, the magnetic grains are substantially evenly segregated. Thereby, medium noise is reduced. The material of the magnetic materials is not to be limited in particular as long as it is a non-solid solution. The material of the magnetic materials may be selected from the non-solid solution layer of the above-described intermediate layer structure.

Since the first magnetic layer 22 and the second magnetic layer 23 are configured in a manner that the first magnetic layer 22 is in intimate contact with the second magnetic layer 23, the first magnetic layer 22 and the second magnetic layers 23 form an exchange coupled structure having the two layers ferromagnetically exchange coupled (hereinafter referred to as “ferromagnetic exchange coupled structure”). Furthermore, the second magnetic layer 23 and the third magnetic layer 25 form an exchange coupled structure having the two layers anti-ferromagnetically exchange coupled via the non-magnetic coupling layer 24 (hereinafter referred to as “anti-ferromagnetically exchange coupled structure”). For example, as shown in FIG. 1 (remanence state), the magnetization of the first magnetic layer 22 and the magnetization of the second magnetic layer 23 become parallel while the magnetization of the third layer 25 become anti-parallel with respect to the magnetizations of the first and second magnetic layers 22, 23. Accordingly, since the recording layer 21 includes the anti-ferromagnetic exchange coupling structure, the thermal stability of the remanent magnetization of the entire recording layer 21 is increased. That is, since the volume of one bit is in proportion to the total sum of the thickness of the first-third magnetic layers 22, 23, and 25, the volume of one recorded bit increases. Accordingly, KuV/k_{B}T, which is the index of thermal stability of the remanent magnetization, increases. It is to be noted that “Ku” indicates a uniaxial anisotropy integer, “V” indicates volume, “k_{B}” indicates a Boltzman's constant, and “T” indicates temperature. Accordingly, thermarmal stability increases as the value of KuV becomes greater.

Since the recording layer 21 includes the anti-ferromagnetic exchange coupling structure, demagnetization field can be reduced. The demagnetization field is induced towards a direction opposite to the direction of the remanent magnetizations of the first and second magnetic layers 22, 23. This is advantageous for high density recording since the range of the magnetization transition region between neighboring remanent magnetization areas can be reduced.

It is preferable for the product of the remanent magnetization thickness to satisfy a relationship of (Mr₁×t₁+Mr₂×t₂>Mr₃×t₃) wherein Mr₁, Mr₂, and Mr₃ indicate the first, second, and third magnetic layers 22, 23, 25, and t₁, t₂, and t₃ indicate the thicknesses of the first, second, and third magnetic layers 22, 23, 25. Since the magnetic fields of the ferromagnetically exchange coupled first and second magnetic layers 22, 23 become the signal magnetic field, a satisfactory reproduction characteristic can be attained.

Furthermore, it is preferable for the thicknesses of the first, second, and third magnetic layers 22, 23, 25 to satisfy a relationship of (t₁+t₂>t₃). Since the thicknesses of the first and second magnetic layers 22, 23 can be increased (compared to a case of not providing the third magnetic layer 25) by satisfying the above relationship, the crystallinity and crystal orientation for the first and second magnetic layers 22, 23. Thus, the satisfactory crystallinity and crystal orientation of the first magnetic layer 22 provides a beneficial influence to the crystallinity and crystal orientation of the second magnetic layer 23.

Next, an example of a satisfactory configuration of the recording layer 21 is described. In the recording layer 21 of this example, the first magnetic layer 21 has a ferromagnetic granular structure, the second magnetic layer 22 has a ferromagnetic continuous structure, and the third magnetic layer 25 also has a ferromagnetic continuous structure. The first magnetic layer 22, acquiring the crystal grain arrangement of the intermediate layer 19, is a low noise magnetic layer having segregated grains therein. Furthermore, the second magnetic layer 23 acquires the crystal grain arrangement and the crystal orientation of the first magnetic layer 21. Thereby, the distribution of range of the magnetic grains in the second magnetic layer 23 can be narrowed and a satisfactory crystal orientation can be obtained. Moreover, since the second magnetic layer 23 has a greater remanent magnetic flux density than the first magnetic layer 22 (to the extent the second magnetic layer 23 not having a non-solid solution layer). Therefore, it is easier to increase reproduction output. Furthermore, the third magnetic layer 25 acquires the crystal grain arrangement and the crystal orientation of the second magnetic layer 23. Thereby, the perpendicular coercivity of the first and second magnetic layers 22, 23 further increase. In this case, since the anisotropic magnetic fields of the first and second magnetic layers 22, 23 are substantially constant, there is substantially no change in the inverted magnetic field strength. Accordingly, the increase of perpendicular coercivity improves the thermal stability of the remanent magnetization without adversely affecting the recording performance.

The material of the protective layer 28 is not to be limited in particular. The protective layer 28 may include, for example, an amorphous carbon, a carbon hydride, a carbon nitride, or an aluminum oxide having a thickness ranging from 0.5 nm to 15 nm. The lubricant layer 29 is not to be limited in particular. The lubricant layer 29 may include, for example, a lubricant of a perfluoropolyether main chain having a thickness ranging from 0.5 nm to 5 nm. The lubricant layer 29 is coated on the surface of the protective layer 28 by applying a solution diluted with a solvent with use of an immersion method or a spraying method. The lubricant layer 29 may be provided in accordance with the material of the protective layer 28 or the lubricant layer 29 may not be formed in the first place.

Although it is preferred for the perpendicular magnetic recording medium 10 to include the under-layer 18 and the intermediate layer 19 so that the first-third magnetic layers 22, 23, and 25 can attain a satisfactory crystal orientation, the under-layer 18 and the intermediate layer 19 may be omitted. In a case where the intermediate layer 19 is not include, the crystal orientation of the first-third magnetic layers 22, 23, and 25 are formed in accordance with the crystal orientation of the under-layer 18 and their magnetic easy axes are oriented substantially perpendicular to the substrate surface. Furthermore, in a case where both the under-layer 18 and the intermediate layer 19 are not included, the first magnetic layer 22 grows by itself on the separating layer 16 and is formed having its magnetic easy axis oriented substantially perpendicular to the substrate surface.

The method used for forming (depositing) the respective layers of the perpendicular magnetic recording medium 10 according to the first example of the first embodiment of the present invention is not to be limited in particular. For example, the layers may be formed by using a sputtering method using inert gas (e.g. in an Ar gas atmosphere). In the deposition process, it is preferred to heat the substrate 11 for preventing crystallization of the amorphous soft magnetic material layers 13, 15 of the soft magnetic under layered structure 12. The substrate 11 may, however, be heated to a temperature that can avoid crystallization of the amorphous soft magnetic material layers 13, 15. Furthermore, the substrate 11 may be heated for removing unwanted substances (e.g. moisture) from prescribed parts (e.g. surface) of the substrate 11 prior to the forming of the amorphous soft magnetic material layers 13, 15. The substrate 11 is, however, to be cooled after the heating. Since the method of forming the perpendicular magnetic recording medium 10 is the same for the below-described second-fourth examples of the perpendicular magnetic recording medium, further description thereof is omitted.

In the above-described perpendicular magnetic recording medium 10 (first example), each magnetic layer of the recording layer 21 includes ferromagnetic material comprising Co alloy having an hcp structure. The (0002) crystal plane of Co is formed having a satisfactory lattice arrangement. Thereby, the magnetic easy axis can be satisfactorily oriented, and perpendicular coercivity can be increased. Furthermore, the recoding layer 21 has an anti-ferromagnetically exchange coupled configuration. Accordingly, the increase of perpendicular coercivity and the anti-ferromagnetic exchange coupling serve to improve thermal stability of remanent magnetization. Meanwhile, a low anisotropic magnetization can be set owing to the increase of perpendicular coercivity. This ensures satisfactory writability.

Furthermore, the perpendicular magnetic recording medium 10 (first example) has the anti-ferromagnetic exchange coupled configuration positioned toward the protective layer 28 of the recording layer 21. Thereby, the thermal stability of remanent magnetization can be further improved. Moreover, the reversing of magnetization of the first and second magnetic layers 22, 23 during recording can be simplified by selecting a suitable exchange coupling field strength.

Next, another perpendicular magnetic recording medium 30 (second example) according to the first embodiment of the present invention is described. The perpendicular magnetic recording medium 30 is a modified version of the above-described perpendicular magnetic recording medium 10 (first example) according to the first embodiment of the present invention.

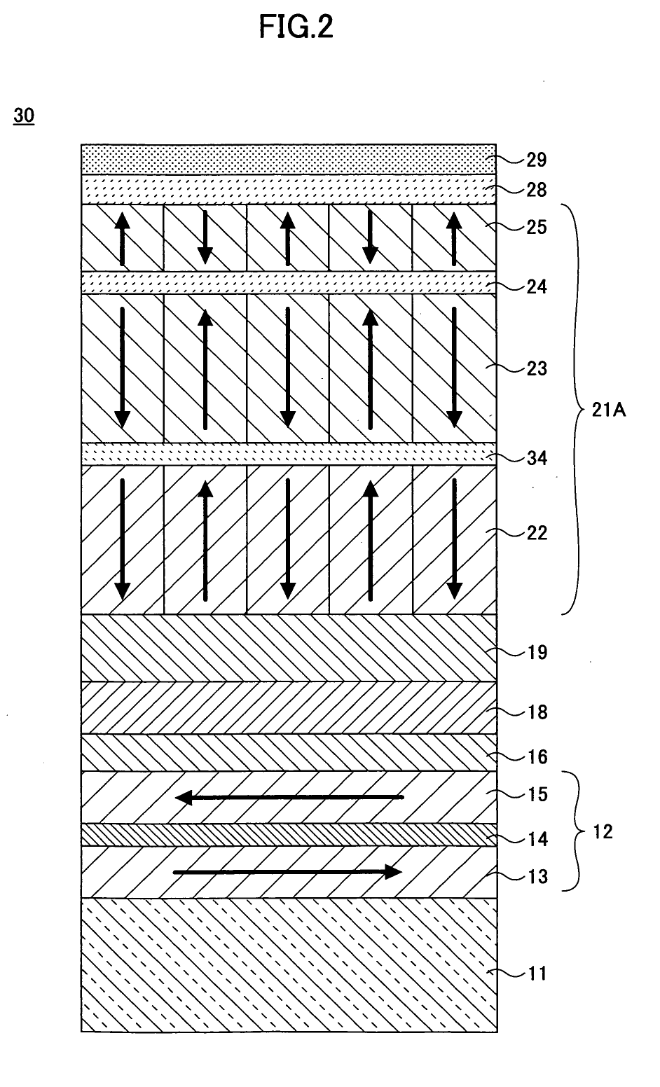

FIG. 2 is a cross-sectional view showing the perpendicular magnetic recording medium 30 according to the first embodiment of the present invention. In FIG. 2, like parts and components are denoted with like reference numerals of FIG. 1 and further description thereof is omitted.

In FIG. 2, in the perpendicular magnetic recording medium 30, the recording layer 21A includes a first magnetic layer 22, a non-magnetic coupling layer (second non-magnetic coupling layer) 34, a second magnetic layer 23, another non-magnetic coupling layer (first non-magnetic coupling layer) 24, and a third magnetic layer 25 that are layered on the intermediate layer 19 in this order. The recording layer 21A includes an anti-ferromagnetic exchange coupling structure having the first magnetic layer 22 anti-ferromagnetically exchange-coupled to the second magnetic layer 23 via the the non-magnetic coupling layer 34. In addition, the recording layer 21A further includes another anti-ferromagnetic exchange coupling structure having the second magnetic layer 23 anti-ferromagnetically exchange-coupled to the third magnetic layer 25 via the non-magnetic coupling layer 24. The recording layer 21A has substantially the same configuration as that of the recording layer 21 of the above-described perpendicular magnetic recording medium 10 except for the fact that the non-magnetic coupling layer 34 is included.

In this example, the material of the non-magnetic coupling layer 24 is selected as the material of the non-magnetic coupling layer 34. The exchange coupling field strength of the ferromagnetic exchange coupling between the first magnetic layer 22 and the second magnetic layer 23 is controlled by adjusting the thickness of the non-magnetic coupling layer 34. For example, as the thickness of the non-magnetic coupling layer 34 increases from 0 nm, the exchange coupling field strength of the gradually decreases. By reducing the exchange coupling field strength, the coercivity of the entire recording layer 21A can be reduced. This ensures satisfactory writability. Although the thickness of the non-magnetic coupling layer 34 is determined depending on the material and thickness of the first and second magnetic layers 22, 23, a thickness greater than 0 nm is preferred. A more preferred thickness ranges from 0.2 nm to 2.5 nm. The non-magnetic coupling layer 34 anti-ferromagnetically couples the first and second magnetic layers 22, 23 by using the RKKY (Ruderman-Kittel-Kasuya-Yoshida) interaction.

In addition to providing the same advantages of the perpendicular magnetic recording medium 10, the perpendicular magnetic recording medium 30 can control the inverse magnetic field strength of the entire recording layer 21A by utilizing the non-magnetic coupling layer for controlling the exchange coupling field strength of the ferromagnetically exchange coupled first and second magnetic layers 22, 23. Particularly, a satisfactory writability can be attained by controlling the non-magnetic coupling layer 34 for reducing the inverse magnetic field strength.

Next, another perpendicular magnetic recording medium 40 (third example) according to the first embodiment of the present invention is described. The perpendicular magnetic recording medium 40 is another modified version of the perpendicular magnetic recording medium 10 (first example) according to the first embodiment of the present invention.

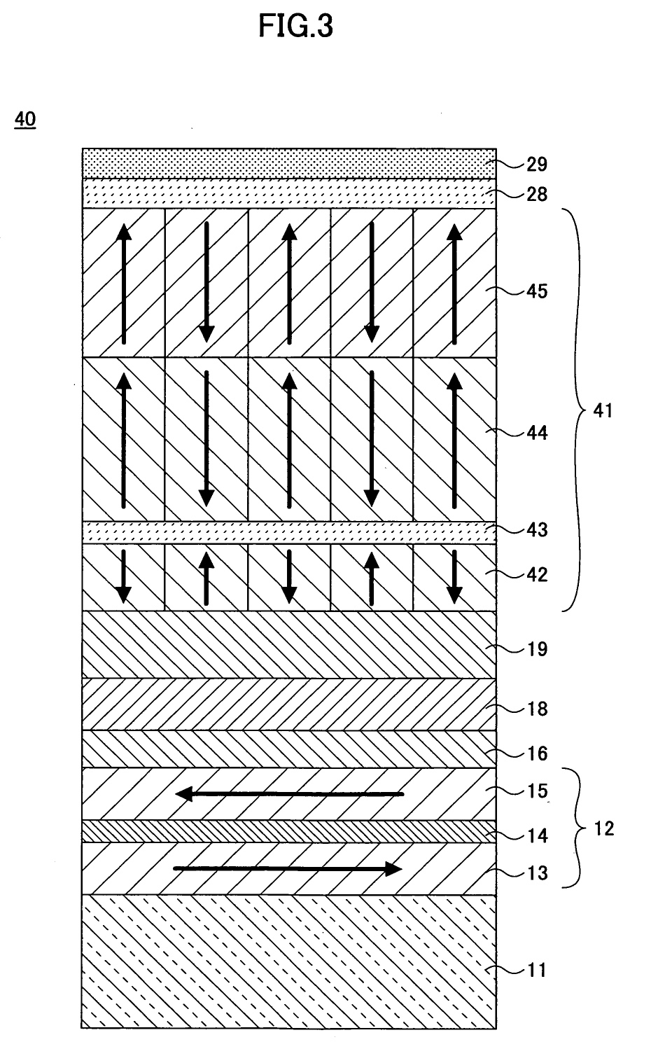

FIG. 3 is a cross-sectional view showing the perpendicular magnetic recording medium 40 according to the first embodiment of the present invention. In FIG. 3, like parts and components are denoted with like reference numerals of FIG. 1 and further description thereof is omitted.

In FIG. 3, the perpendicular magnetic recording medium 40 includes a substrate 11 and a multilayer configuration provided on the substrate 11, in which the multilayer configuration includes a soft magnetic under layered structure 12, a separating layer 16, an under-layer 18, an intermediate layer 19, a recording layer 41, a protective layer 28, and a lubricant layer 29 that are layered on the substrate 11 in this order. The recording layer 41 includes a first magnetic layer 42, a non-magnetic coupling layer 43, a second magnetic layer 44, and a third magnetic layer 45 that are layered on the intermediate layer 19 in this order. The recording layer 41 includes an anti-ferromagnetic exchange coupling structure having the first magnetic layer 42 anti-ferromagnetically exchange-coupled to the second magnetic layers 44 via the non-magnetic coupling layer 43. The perpendicular magnetic recording medium 40 has substantially the same configuration as that of the above-described perpendicular magnetic recording medium 10 except for the fact that the anti-ferromagnetic exchange coupling structure is situated toward the intermediate layer 19.

In this example, the material used in the first-third magnetic layers 42, 44, 45 of the perpendicular magnetic recording medium 40 is the same as that of the first-third magnetic layers 22, 23, 25 of the perpendicular magnetic recording medium 40. Furthermore, the first magnetic layer 42, the non-magnetic coupling layer 43, the second magnetic layer 44, and the third magnetic layer 45 of the perpendicular magnetic recording medium 40 correspond to the third magnetic layer 25, the non-magnetic coupling layer 24, the first magnetic layer 22, and the second magnetic layer 23 of the perpendicular magnetic recording medium 10.

In the perpendicular magnetic recording medium 40 (third example), each magnetic layer 42, 44, 45 of the recording layer 41 includes ferromagnetic material comprising Co alloy having an hcp structure. The (0002) crystal plane of Co is formed having a satisfactory lattice arrangement. Thereby, the magnetic easy axis can be satisfactorily oriented, and perpendicular coercivity can be increased. Furthermore, the recoding layer 41 has an anti-ferromagnetically exchange coupled configuration. Accordingly, the increase of perpendicular coercivity and the anti-ferromagnetic exchange coupling serve to improve thermal stability of remanent magnetization. Meanwhile, a low anisotropic magnetization can be set owing to the increase of perpendicular coercivity. This ensures satisfactory writability.

Furthermore, the perpendicular magnetic recording medium 40 (third example) has the anti-ferromagnetic exchange coupled configuration positioned toward the intermediate layer 19. Thereby, the thermal stability of remanent magnetization can be further improved. By selecting a suitable magnetic grain and grain size distribution for the first magnetic layer 42, the grain size and grain size distribution of the magnetic grains of the second and third magnetic layers 44, 45 formed above the first magnetic layer 42 can be controlled. As a result, the magnetic properties of the entire recording layer 41 can be improved and medium noise can be reduced.

It is to be noted that the perpendicular magnetic recording medium 40 may further have a non-magnetic coupling 34 (as in the above-described recording layer 21A of the perpendicular magnetic recording medium 30) provided between the second magnetic layer 44 and the third magnetic layer 45. Thereby, the magnetic field strength of the ferromagnetic exchange coupling between the second magnetic layer 44 and the third magnetic layer 45 can be controlled.

Next, another perpendicular magnetic recording medium 50 (fourth example) according to the first embodiment of the present invention is described. The perpendicular magnetic recording medium 50 is yet another modified version of the perpendicular magnetic recording medium 10 (first example) according to the first embodiment of the present invention.

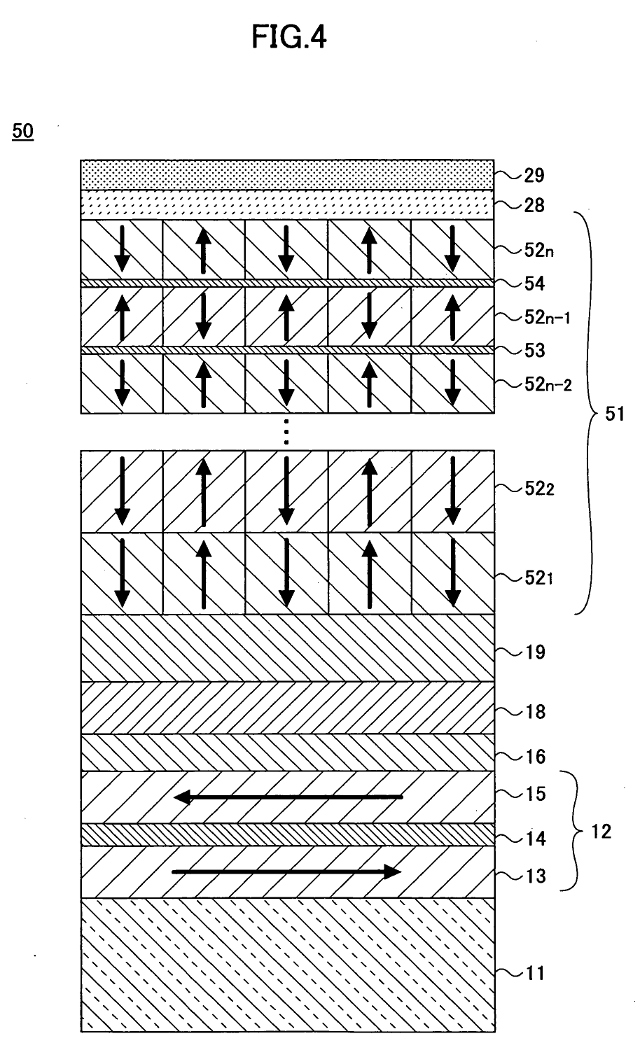

FIG. 4 is a cross-sectional view showing the perpendicular magnetic recording medium 50 according to the first embodiment of the present invention. In FIG. 4, like parts and components are denoted with like reference numerals of FIG. 1 and further description thereof is omitted.

In FIG. 4, the perpendicular magnetic recording medium 50 includes a substrate 11 and a multilayer configuration provided on the substrate 11, in which the multilayer configuration includes a soft magnetic under layered structure 12, a separating layer 16, an under-layer 18, an intermediate layer 19, a recording layer 51, a protective layer 28, and a lubricant layer 29 that are layered on the substrate 11 in this order. The recording layer 51 includes a first magnetic layer 52₁, a second magnetic layer 52₂, . . . a (n−2) th magnetic layer 52ₙ₋₂, a non-magnetic coupling layer 53, a (n−1) th magnetic layer 52ₙ₋₁, a non-magnetic coupling layer 54, and a n th magnetic layer 52ₙ that are layered on the intermediate layer 19 in this order. It is, however, to be noted that “n” is an integer that is no less than 4. The recording layer 51 includes an anti-ferromagnetic exchange coupling structure having the (n−2) th magnetic layer 52ₙ₋₂ anti-ferromagnetically exchange-coupled to the (n−1) th magnetic layer 52ₙ₋₁ via the non-magnetic coupling layer 53. Furthermore, the recording layer 51 includes another anti-ferromagnetic exchange coupling structure having the (n−1) th magnetic layer 52ₙ₋₁ anti-ferromagnetically exchange-coupled to the n th magnetic layer 52ₙ via the non-magnetic coupling layer 54.

In this example, the material of the first-nth magnetic layers 52₁-52ₙ, is selected from the material used for the first-third magnetic layers 23, 23, 25. The material of the non-magnetic coupling layers 53, 54 is selected from the material used for the non-magnetic coupling layer 24 of the perpendicular magnetic recording medium 10. The recording layer 51 has two anti-ferromagnetically exchange coupling structures provided toward the protective layer 28, in which the direction of the remanent magnetization of the 52ₙ₋₁ becomes anti-parallel with that of the other magnetic layers 52₁-52ₙ₋₂, 52ₙ. Accordingly, the increase of perpendicular coercivity and the anti-ferromagnetic exchange coupling serve to improve thermal stability of remanent magnetization. Meanwhile, a low anisotropic magnetization can be set owing to the increase of perpendicular coercivity. This ensures satisfactory writability.

Furthermore, the perpendicular magnetic recording medium 10 (first example) has the anti-ferromagnetic exchange coupled configuration positioned toward the protective layer 28 of the recording layer 21. Thereby, the thermal stability of remanent magnetization can be further improved. Moreover, the reversing of magnetization of the first and second magnetic layers 22, 23 during recording can be simplified by selecting a suitable exchange coupling field strength.

In addition to providing the same advantages of the perpendicular magnetic recording medium 10, the perpendicular magnetic recording medium 50 can control the enlargement of magnetic grains since the respective magnetic layers 52₁-52ₙ₋₂ can be formed thinner than the magnetic layers of the perpendicular magnetic recording medium 10. As a result, the perpendicular magnetic recording medium 50 can reduce medium noise and increase the SN ratio.

It is to be noted that the non-magnetic coupling layers 53, 54 that form the anti-ferromagnetic coupling structure may also be provided between other magnetic layers. Furthermore, three or more layers of the non-magnetic coupling layer may be provided in the perpendicular magnetic recording medium 50.

Next, samples of the perpendicular magnetic recording medium (perpendicular magnetic disk) according to the first embodiment of the present invention are described below.

### [First Sample]

The below-described first sample was fabricated having substantially the same configuration as the above-described perpendicular magnetic recording medium 10 (first example) shown in FIG. 1. The reference numerals used in FIG. 1 are used below for indicating each layer. The values indicated inside the below-given parenthesis represent layer thickness.

substrate 11: glass substrate
soft magnetic under layered structure 12
amorphous soft magnetic material layers 13, 15: CoNbZr layer (25 nm each)
non-magnetic coupling layer 14: Ru layer (0.6 nm)
   separating layer 16: Ta layer (3 nm)
   under-layer 18: NiFe—Cr layer (3 nm)
   intermediate layer 19: Ru layer (20 nm)
   recording layer 21
first magnetic layer 22:
   CoCrPt—SiO₂ layer (10 nm)
second magnetic layer 23:
   CoCrPtB layer (6 nm)
non-magnetic coupling layer 24:
   Ru layer (0.6 nm)
third magnetic layer 25:
   CoCr layer
      protective layer 28: carbon layer (4.5 nm)
      lubricant layer 29: perfluoropolyether (1.5 nm)

It is to be noted that three variations of the first sample was fabricated, in which the CoCr layer of the third magnetic layer 25 was formed with a thickness ranging from 1 nm to 3 nm (See FIG. 6).

In fabricating the first sample, a washed glass substrate is conveyed to a deposition chamber of a sputtering apparatus. Then, respective layers (except for the lubricant layer) are formed without heating the substrate by using a DC magnetron method. In this method, each layer is formed by filling the deposition chamber with argon gas and setting the pressure to 0.7 Pa. Then, the lubricant layer is coated thereon by using an immersion method.

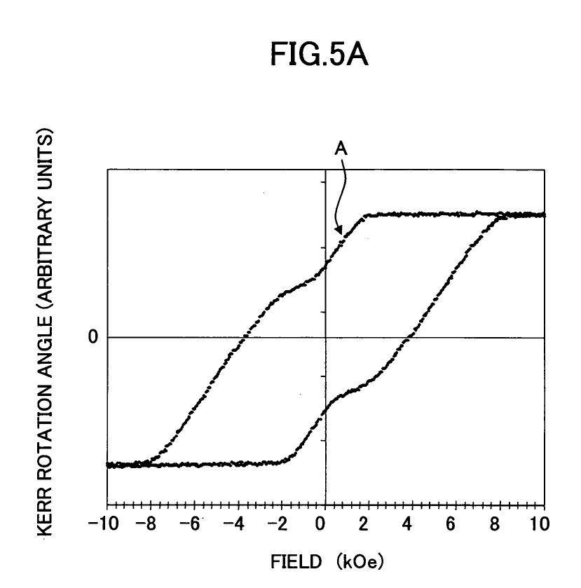

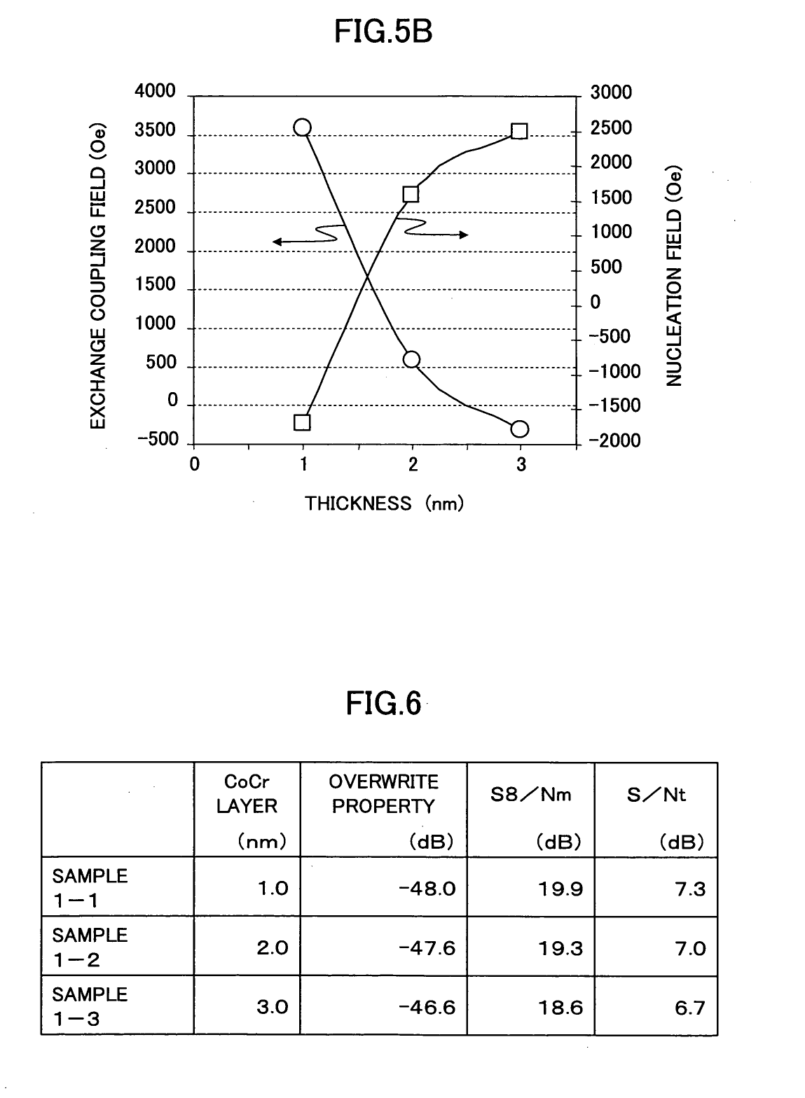

FIG. 5A is a table showing an exemplary hysteresis curve of the first sample of the perpendicular magnetic recording medium according to the first embodiment of the present invention, and FIG. 5B is a table showing magnetic properties of the first sample of the perpendicular magnetic recording medium according to the first embodiment of the present invention. FIG. 5A shows a case where the layer thickness of the CoCr layer of the third magnetic layer 25 is 2 nm. The kerr rotation angle was measured where hysteresis curve shown in FIG. 5A traces the applied magnetic field in an order of 0 (zero)→+10 kOe →0 (zero)→−10 kOe. It is to be noted that the same measuring conditions was applied to below-described second sample.

As shown in FIG. 5A, the step (slope) indicated with an arrow A is created owing that the exchange coupling field affecting the CoCr layer becomes greater than the applied magnetic field and the magnetization of the CoCr film becomes reversed. The exchange coupling field in this case can be obtained from the minor loop obtained by applying magnetic field in the foregoing order and changing the applied magnetic field from approximately −2 kOe→0 (zero)→+2 kOe. In this hysteresis curve, the exchange coupling field is 700 Oe shown in FIG. 5A. Furthermore, the nucleation field according to FIG. 5A is 1600 Oe.

As shown in FIG. 5B, the exchange coupling field is a positive value when the thickness of the CoCr layer is 1 nm or 2 nm and is a negative value when the thickness of the CoCr layer is 3 nm. In a case where the exchange coupling field is a positive value, the direction of magnetization of the CoCr layer becomes opposite to that of the CoCrPt—SiO₂ layer and the CoCrPtB layer (first and second layers) at remanent magnetization state (i.e. where no magnetic field is applied from outside). This shows that the CoCr layer is preferred to have a layer thickness of 2 nm or less. In addition, considering the tendency of the curve of the exchange coupling field, it can be understood that the CoCr layer may be formed with a thickness of approximately 0.2 nm.

The nucleation field indicates the squareness of the hysteresis curve, in which a small value is preferred in a case of a positive value and a large value (absolute value) is preferred in a case of a negative value. The relationship between the nucleation field and the thickness of the CoCr layer shows that a satisfactory squareness can be attained the thinner the CoCr layer.

FIG. 6 is a table showing reading/writing properties of the first sample of the perpendicular magnetic recording medium according to the first embodiment of the present invention. In the table, “S8/Nm” indicates the SN ratio between the average output S8 and the medium noise Nm where the linear recording density is 112 kBPI. “S/Nt” indicates the SN ratio between the average output S and the total noise (=medium noise+device noise) where the linear recording density is 450 kBPI. The overwrite property, the value of the S8/Nm, and the value of the S/Nt was measured by using a composite head having an induction type recording element and a GMR element and a commercially available spin stand. It is to be noted that the same measuring conditions was applied to below-described second sample.

As shown in FIG. 6, an overwrite property less than −46 db is obtained in a case where the thickness of the CoCr layer ranges between 1 nm to 3 nm. Furthermore, the values of the S8/Nm and the S/Nt show that a more satisfactory SN ratio can be attained as the CoCr layer becomes thinner.

Considering the magnetic property and the reading/writing property, the CoCr layer is preferred to have a thickness that is no less than 0.2 nm and no more than 2.0 nm. It is more preferable for the CoCr layer to have a thickness that is no less than 0.2 nm and no more than 1.5 nm.

### [Second Sample]

The below-described second sample was fabricated having substantially the same configuration as the above-described perpendicular magnetic recording medium 40 (third example) shown in FIG. 3. The reference numerals used in FIG. 3 are used below for indicating each layer. The values indicated inside the below-given parenthesis represent layer thickness.

substrate 11: glass substrate
soft magnetic under layered structure 12
amorphous soft magnetic material layers 13, 15: CoNbZr layer (25 nm each)
non-magnetic coupling layer 14: Ru layer (0.6 nm)
   separating layer 16: Ta layer (3 nm)
   under-layer 18: NiFe—Cr layer (3 nm)
   intermediate layer 19: Ru layer (20 nm)
   recording layer 41
first magnetic layer 42:
   CoCr layer
non-magnetic coupling layer 43:
   Ru layer (0.6 nm)
second magnetic layer 44:
   CoCrPt—SiO₂ layer (10 nm)
third magnetic layer 45:
   CoCrPtB layer (6 nm)
      protective layer 28: carbon layer (4.5 nm)
      lubricant layer 29: perfluoropolyether (1.5 nm)

It is to be noted that two variations of the second sample was fabricated, in which the CoCr layer of the first magnetic layer 42 was formed with a thickness of 1 nm and 2 nm (See FIG. 8). The method of fabricating the second sample is substantially the same as that of the first sample. The compositions of the CoCrPt—SiO2 layer and the CoCrPtB layer (second and third magnetic layers) are substantially the same as those of the first and second magnetic layers of the first sample.

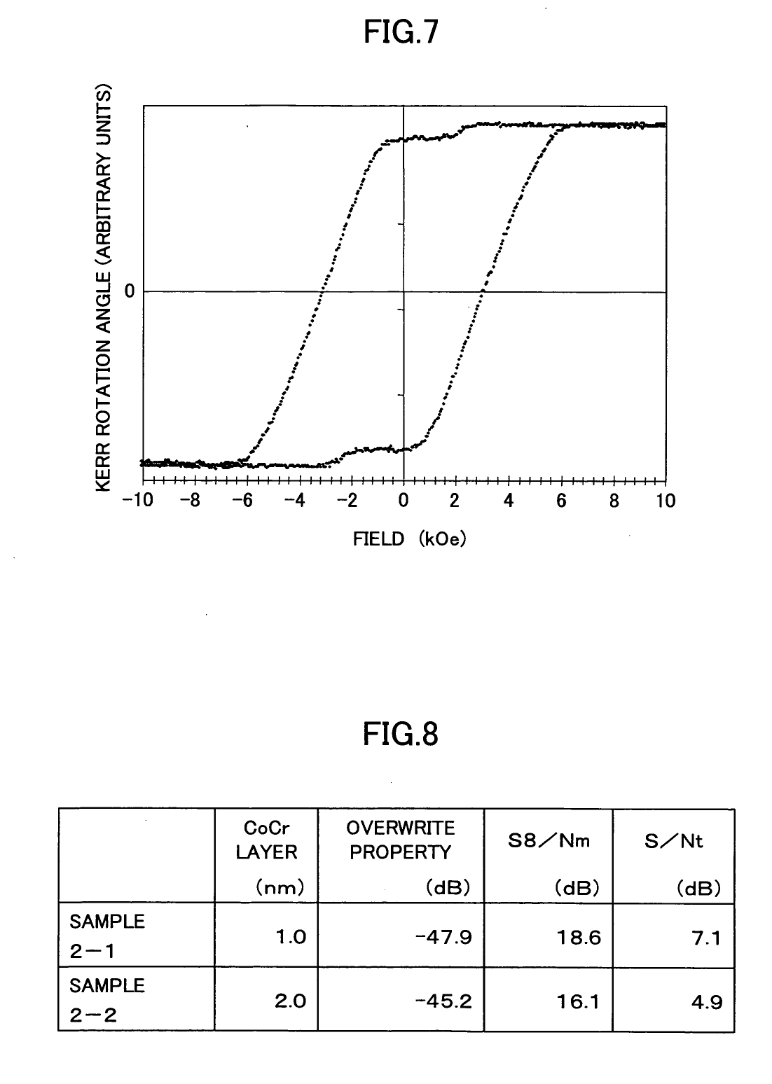

FIG. 7 is a table showing a hysteresis curve of the second sample of the perpendicular magnetic recording medium according to the first embodiment of the present invention. In FIG. 7, a step was found in a case where the thickness of the CoCr layer (first magnetic layer) is 2 nm. In this case, the exchange magnetic field is 2400 Oe. Although not shown in the table, no step was found and no exchange magnetic field was obtained in a case where the thickness of the CoCr layer (first magnetic layer) is 1 nm. This is due to insufficient measuring sensitivity. It is considered that the CoCr layer is anti-ferromagnetically exchange coupled.

FIG. 8 is a table showing reading/writing properties of the second sample of the perpendicular magnetic recording medium according to the first embodiment of the present invention. In the table, the CoCr layer exhibits a satisfactory overwrite property of −45 dB or less when the layer thickness ranges between 1 nm to 2 nm. Furthermore, the values of the S8/Nm and the S/Nt show that a more satisfactory SN ratio can be attained as the CoCr layer becomes thinner.

### Second Embodiment

The second embodiment of the present invention relates to a magnetic memory apparatus including one of the perpendicular magnetic recording media (first example-fourth example) according to the first embodiment of the present invention.

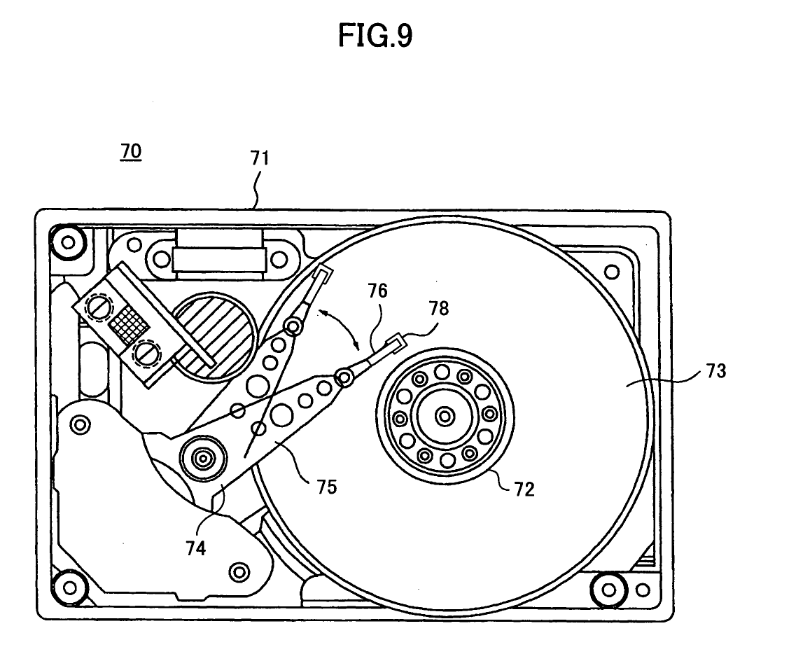

FIG. 9 is a schematic plan view of a part of a magnetic memory apparatus 70 according to the second embodiment of the present invention. As shown in FIG. 9, the magnetic memory apparatus 70 includes a housing 71. The housing 71 includes, for example, a hub 72 that is driven by a spindle (not shown), a perpendicular magnetic recording medium 73 that is fixed and rotated on the hub 72, an actuator unit 74, an arm 75 and a suspension part 76 that are attached to the actuator unit 74 and moved in the radial direction of the perpendicular magnetic recording medium 73, and a magnetic head 78 that is supported by the suspension part 76.

The magnetic head 78 includes, for example, a monopole type recording head and a reproduction head having a GMR (Giant Magneto Resistive) element.

Although not shown in the drawing, the monopole type recording head includes, for example, a main pole comprising a soft magnetic material for applying a recording magnetic field to the perpendicular magnetic recording medium 73, a return yoke that is magnetically connected to the main pole, and a recording coil for inducing the recording magnetic field to the main pole and the return yoke. The monopole type recording head forms a perpendicular magnetization in the perpendicular magnetic recording medium 73 by applying a recording magnetic field from its main pole to the perpendicular magnetic recording medium 73 in a perpendicular direction.

The GMR element included in the reproduction head detects resistance change by referring to the direction of the leaking magnetic field of the magnetization of the perpendicular magnetic recording medium 73 and obtains information recorded in the recording layer of the perpendicular magnetic recording medium 73. A TMR (Ferromagnetic Tunnel Junction Magneto Resistive) element, for example, may be used as an alternative for the GMR element.

The perpendicular magnetic recording medium 73 corresponds to one of the perpendicular magnetic recording media (first-fourth example) of the first embodiment of the present invention. The perpendicular magnetic recording medium 73 has satisfactory writability and thermal stability of remanent magnetization.

The configuration of the magnetic memory apparatus 70 of the second embodiment is not to be limited to the one shown in FIG. 9. Furthermore, a magnetic head other than the magnetic head 78 may be used. Although the foregoing embodiment describe the perpendicular magnetic recording medium 73 as a magnetic disk, the perpendicular magnetic recording medium 73 may also be, for example, a magnetic tape.

Accordingly, the magnetic memory apparatus 70 according to the second embodiment of the present invention can achieve reliably write data at high recording density by using the perpendicular magnetic recording medium 73 having satisfactory writability and thermal stability of remanent magnetization.

Further, the present invention is not limited to these embodiments, but variations and modifications may be made without departing from the scope of the present invention.

The present application is based on Japanese Priority Application No. 2006-100596 filed on Mar. 31, 2006, with the Japanese Patent Office, the entire contents of which are hereby incorporated by reference.

What is claimed is:

1. A perpendicular magnetic recording medium comprising:
a substrate; and
a recording layer formed on the substrate, the recording layer having a magnetic easy axis substantially perpendicular to the surface of the substrate and including three or more magnetic layers containing a Co alloy having a hcp structure;
wherein two of the magnetic layers included in the recording layer form an anti-ferromagnetic exchange coupling structure;
wherein the two magnetic layers are anti-ferromagnetically exchange coupled via a non-magnetic coupling layer situated therebetween;
wherein the magnetizations of the two magnetic layers are anti-parallel to each other at a remanent magnetization state.

2. The perpendicular magnetic recording medium as claimed in claim 1, further comprising:
a ferromagnetic exchange coupling structure including two adjacent magnetic layers being ferromagnetically exchange coupled to each other; wherein the two adjacent magnetic layers includes upper and lower magnetic layers having the upper magnetic layer crystal grown on the lower magnetic layer.

3. The perpendicular magnetic recording medium as claimed in claim 1, wherein the anti-ferromagnetic exchange coupling structure is situated in a position nearest to the substrate or farthest from the substrate.

4. The perpendicular magnetic recording medium as claimed in claim 1, wherein among the two magnetic layers of the anti-ferromagnetic exchange coupling structure, one of the magnetic layers having a magnetization oriented in a direction opposite to the write field direction at a remanent magnetization state includes a ferromagnetic material having a higher saturation flux density than the other magnetic layer.

5. The perpendicular magnetic recording medium as claimed in claim 1, one of the magnetic layers includes a plurality of magnetic grains that are separated from each other by a non-magnetic grain boundary part.

6. The perpendicular magnetic recording medium as claimed in claim 1, wherein one of the magnetic layers includes a plurality of magnetic grains that are separated from each other by a space part or a non-solid solution part.

7. The perpendicular magnetic recording medium as claimed in claim 1, wherein the Co alloy having the hcp structure includes at least one of CoCr, CoPt, CoCrTa, CoCrPt and CoCrPt-M, wherein M includes at least one of B, Ta, Cu, W, Mo, and Nb.

8. The perpendicular magnetic recording medium as claimed in claim 1, wherein the recording layer includes a first magnetic layer, a second magnetic layer, a non-magnetic coupling layer, and a third magnetic layer that are layered on the substrate in this order; wherein the second and third magnetic layers form the anti-ferromagnetic exchange coupling structure; wherein the third magnetic layer includes a ferromagnetic material having a higher saturation flux density than the second magnetic layer.

9. The perpendicular magnetic recording medium as claimed in claim 8, wherein the second magnetic layer includes a plurality of magnetic grains that are separated from each other by a space part or a non-solid solution part; wherein the third magnetic layer includes a plurality of magnetic grains that are separated from each other by a non-magnetic grain boundary part.

10. The perpendicular magnetic recording medium as claimed in claim 1, wherein the recording layer includes a first magnetic layer, a non-magnetic coupling layer, a second magnetic layer and a third magnetic layer that are layered on the substrate in this order; wherein the first and second magnetic layers form the anti-ferromagnetic exchange coupling structure; wherein the first magnetic layer includes a ferromagnetic material having a higher saturation flux density than the second magnetic layer.

11. The perpendicular magnetic recording medium as claimed in claim 8, wherein the first magnetic layer includes a plurality of magnetic grains that are separated from each other by a space part or a non-solid solution part; wherein the second magnetic layer includes a plurality of magnetic grains that are separated from each other by a non-magnetic grain boundary part.

12. The perpendicular magnetic recording medium as claimed in claim 1, wherein the non-magnetic coupling layer includes at least one of Ru, Cu, Cr, Rh, Ir, Ru alloy, Rh alloy, and a Ir alloy.

13. The perpendicular magnetic recording medium as claimed in claim 1, further comprising:
a soft magnetic under layered structure and a separating layer layered on the substrate in this order between the substrate and the recording layer;
wherein the soft magnetic under layered structure includes a first soft magnetic material layer, another non-magnetic coupling layer, and a second soft magnetic material layer that are layered on the substrate in this order;
wherein the first and second magnetic material layers have an inplane magnetic easy axis;
wherein the magnetization of the first and second soft magnetic material layers are oriented in an inplane direction and are anti-ferromagnetically coupled to each other.

14. The perpendicular magnetic recording medium as claimed in claim 13, wherein the separating layer includes at least one of Ta, Ti, C, Mo, W, Re, Os, Hf, Mg, and Pt.

15. The perpendicular magnetic recording medium as claimed in claim 1, further comprising:
an intermediate layer situated under the recording layer;
wherein the intermediate layer includes a crystalline material for generating crystal growth of the magnetic layers in the recording layer.

16. The perpendicular magnetic recording medium as claimed in claim 15, wherein the intermediate layer includes at least one of Ru, Pd, Pt, and Ru—X1, wherein X1 includes at least one of Ta, Nb, Co, Cr, Fe, Ni, Mn, and C.

17. The perpendicular magnetic recording medium as claimed in claim 16, wherein the intermediate layer includes a plurality of crystal grains that grown in a perpendicular direction with respect to the substrate surface, wherein the plural crystal grains are separated from each other by a space part or a non-solid solution part.

18. The perpendicular magnetic recording medium as claimed in claim 16, wherein the plural crystal grains include at least one of Ru and Ru—X1 alloy, wherein X1 includes at least one of Ta, Nb, Co, Cr, Fe, Ni, Mn, SiO₂, and C.

19. The perpendicular magnetic recording medium as claimed in claim 14, further comprising:
an under-layer situated under the intermediate layer; wherein the under-layer includes a crystalline material, wherein the under-layer includes at least one of Ni, NiFe, and NiFe—X2, wherein X2 includes at least one of Cr, Ru, Cu, Si, O, N, and SiO₂.

20. A magnetic memory apparatus comprising:
a recording/reproduction part having a magnetic head; and
the perpendicular magnetic recording medium as claimed in claim 1.
